(19) United States
(12) Patent Application Publication
(10) Pub. No.: US 2008/0011555 A1
(43) Pub. Date: Jan. 17, 2008

(54) Elevating platform

(75) Inventor: Josef Ezechias, Herrenberg (DE)

Correspondence Address: FACTOR & LAKE, LTD, 1327 W. WASHINGTON BLVD., SUITE 5G/H, CHICAGO, IL, 60607, US

(73) Assignee: Eisenmann Foerdertechnik GmbH & Co. KG

(21) Appl. No.: 11/542,696

(22) Filed: Oct. 3, 2006

(30) Foreign Application Priority Data
Oct. 4, 2005 (DE) 102005047486.1

(51) Int. Cl. B60P 1/02; B66B 9/02

(52) U.S. Cl. 187/269; 414/495; 254/264

(57) ABSTRACT

An elevating platform, which serves for lifting and lowering heavy loads, in particular in motor-vehicle manufacture, comprises in a known manner a lower structure which can be arranged on a room floor or another supporting structure. An upper structure, on which the load can be arranged, is connected to the lower structure via a connecting structure which comprises at least one elastically deformable profile element. The vertical dimension of this profile element can be changed by the fact that it can be subjected to a force in the horizontal direction. Through this change of the vertical dimension of the intermediate structure, the upper structure can be raised or lowered with respect to the lower structure.

### RELATED APPLICATIONS

The present invention claims the benefit of the filing date of German Patent Application, Serial No. 10 2005 047 486.1, filed Oct. 4, 2005; the content of which is incorporated by reference herein.

### TECHNICAL FIELD

The invention relates to an elevating platform for lifting and lowering heavy loads, in particular in motor-vehicle manufacture, having
a) a lower structure which can be arranged on a room floor or another supporting structure;
b) an upper structure, on which the load can be arranged;
c) a connecting structure which extends between the lower structure and upper structure and the vertical dimension of which can be changed such that the upper structure can be raised or lowered with respect to the lower structure;
d) a source of force acting on the connecting structure, which brings about the change of the vertical dimension of the connecting structure.

### BACKGROUND OF THE INVENTION

Many different configurations of elevating platforms of this kind are known in materials-handling technology and manufacturing engineering; they serve generally for moving a load from one height to another. In the manufacturing of vehicles, for example, elevating platforms are used to introduce bodies into treatment stations and remove them therefrom again. The introduction can be effected by lowering, for example, into a bath, and the removal by raising from the bath. The introduction may, however, also comprise a lifting movement, for example upon introduction into a dryer, and a lowering movement upon removal. Lifting movements are, in addition, frequently required upon transfer from one conveyor to another.

At present, elevating platforms which use scissors-type lattices as the connecting structure are the most widespread. Generally, to raise the upper structure in this case, a lower end of a scissor limb is subjected to a lateral force, so that the scissors extend. Particularly in the initial part of the stroke here, the geometrical conditions of the force introduction are very unfavourable, so that high forces are required; only when the upper structure has been raised further does the geometry of the force introduction become more favourable. A disadvantage of elevating platforms employing scissors-type lattices is also the relatively high price. The upper structure in scissors-type elevating platforms is, moreover, a component indispensable for the stability of the entire construction.

For strokes below 300 mm, eccentric discs have also being used hitherto as the connecting structure. They too are relatively expensive.

### SUMMARY OF THE INVENTION

The object of the present invention is to design an elevating platform of the kind mentioned at the outset such that the force introduction takes place overall under more favourable geometrical conditions and the costs are lower.

This object is achieved according to the invention in that
e) the connecting structure comprises at least one elastically deformable profile element, the vertical dimension of which can be changed by the fact that it can be subjected to a force in the horizontal direction.

The invention makes use of the fact that elastically deformable profile elements possessing a suitable initial shape are deformed, by subjecting them to a lateral force, such that their dimension perpendicular to the force direction is increased. If the external force is removed, the profile element returns elastically to its initial shape. Such elastically deformable profile elements can be produced relatively inexpensively, for example, from fibre-reinforced plastic, but also from metal, in particular steel. When using the profile elements according to the invention, the horizontal driving forces are converted more favourably into the vertical movement of the upper structure than is the case with the known scissors-type or eccentric elevating platforms.

However, the stroke of elevating platforms according to the invention is naturally not so great compared with scissors-type elevating platforms, for instance. In many applications, however, this disadvantage can be readily accepted, especially as there are measures which can result in an increase of the stroke and these are explained in detail below.

The source of force may comprise a motor and a horizontally running threaded spindle driven by the latter, as well as a threaded nut which can be screwed on the threaded spindle and is in force-fitting connection with a lateral region of a profile element. A source of force of this kind is employed where forces are to be exerted on the lateral region of the profile element in both directions, i.e. tensile and compressive forces.

Where it is sufficient to apply solely a tensile force on the lateral region of the profile element(s), the source of force may comprise a motor and a drum which is driven by the latter and onto which can be wound a flexible drive means, in particular a rope, which is connected to a lateral region of a profile element and runs horizontally at least in the region neighbouring the profile element. The drive via a flexible drive means is even more cost-effective, space-saving and variable than that via a threaded spindle. In addition, the flexible drive means may also be guided in the manner of a block and tackle for amplification of the force.

In the simplest case, the force serving for the elastic deformation of the profile element(s) can be introduced unilaterally at a lateral region of a profile element. However, the consequence of this unilateral type of force introduction is that the upper structure during its vertical movement moves simultaneously to a certain extent horizontally. This is acceptable in many cases without problems.

A horizontal movement of the upper structure occurring simultaneously with the vertical movement can be avoided by the fact that the force can be introduced bilaterally at two opposite lateral regions of the same profile element or different profile elements.

In all cases, the vertical movement of the upper structure with respect to the lower structure is associated with a relative movement between the connecting structure and the upper structure, and also between the connecting structure and the lower structure, at least in certain regions. Where this relative movement takes place therefore, the choice of material should be made such that only a low degree of friction occurs.

To increase the load-carrying capacity of the elevating platform according to the invention, at least two profile elements may be arranged beside one another. In this way, relatively flat but large-area elevating platforms can be obtained.

In this case, neighbouring profile elements butt directly against one another by way of lateral regions. This design is chosen when a greatest possible load-carrying capacity is to be achieved for a predetermined area of the upper structure.

If, in contrast, a lower load-carrying capacity is sufficient while retaining a predetermined area of the upper structure, it is possible for neighbouring profile elements to be laterally spaced from one another. In this case, neighbouring profile elements may be connected to one another by at least one force-transmitting distance piece.

At least one region of at least one profile element is preferably stationarily connected to the lower structure and/or the upper structure. Such a manner of connection may serve for defining the position of the connecting structure between the lower structure and upper structure, that is to say ensuring that the entire connecting structure is not displaced when being subjected to lateral force.

A stationary fastening of a lateral region of a profile element may be sensible where a plurality of profile elements are used beside one another, but do not adjoin one another nor are connected to one another via a separate force-transmitting distance piece. The reaction force to the lateral, deforming force is in this case introduced into the upper or lower structure via the stationary edge region of the profile element.

The stroke which can be achieved with an elevating platform according to the invention can be increased by arranging at least two profile elements above one another. In this case, the strokes which can be achieved with each of the profile elements arranged above one another are added up.

The profile elements arranged above one another may be arranged either in the same direction or in different directions. “In the same direction” is understood here to mean the same orientation of the two profile elements in space, while in the case of an arrangement in opposite directions one of the profile elements is rotated by 180°, so that its upper side becomes the underside.

The elevating platform may be composed of two sub-elevating platforms lying on top of one another, each of which possesses a connecting structure and an upper structure. This embodiment of the invention enables a modular assembly of an elevating platform according to the desired size of stroke from a plurality of identically constructed sub-elevating platforms which, in principle, are all capable of functioning on their own. In this case, it is possible for all of the “sub-elevating platforms” in the “whole elevating platform” to be actuated synchronously by one and the same source of force; alternatively, it is also conceivable for different sub-elevating platforms to be actuated separately from one another by separate sources of force.

In a preferred exemplary embodiment of the invention, at least one profile element is provided, at an upper or lower vertex region by which it lies against the lower structure or against the upper structure or against the vertex region of another profile element, with a rib-like projection which forms a plane supporting surface. In this way, precise force transmission is achieved, not just at a point or line.

The rib-like projection may also be a separate part connected subsequently to the profile element and consisting of a low-friction plastic.

Correspondingly, at least two profile elements may be provided, at their lateral regions butting against one another, with a rib-like projection which forms a plane bearing surface.

Preferably, at least one profile element is open on one side. “Open on one side” is understood here to mean a profile shape which has free edges at the underside or upper side. Examples of such profile elements “open at one side” are those which have the shape of a circular cylinder partial lateral surface or are shaped in the manner of a roof. As a result of a pre-curvature which already exists in the relaxed state, a defined deformation behaviour upon force application is obtained here.

In the case of such elevating platforms with profile elements “open on one side”, at least one free edge of a profile element slides, as already mentioned above several times, with respect to the neighbouring upper or lower structure. It is therefore advisable for this at least one edge of the profile element to be fastened in a component which is slidably guided along the lower structure or upper structure.

The use of a plurality of separate profile elements beside or above one another has the advantage that relatively small components capable of modular assembly may be used to produce the connecting structure. In individual cases, however, it may be more favourable if at least two profile elements are integrally joined together. This design principle may be continued until eventually the whole connecting structure is in one piece.

The at least one profile element may also be of tubular configuration. To raise the upper structure, this tubular profile element is as it were “squeezed” in the horizontal direction.

Tubular profile elements used in the present invention may be open at opposite ends. This makes it possible for the air enclosed in the interior of the profile element to escape on deformation of the profile element and thus have no effect on the deformation properties of the profile element.

It is, however, also possible for the tubular profile element to be closed all the way round. The air present in the profile element is thus confined, so that it is bound to be compressed, for example, on a reduction of volume brought about by the deformation. It thus contributes towards the deformation characteristic of the profile element and can influence, for example, the load-carrying capacity of the entire elevating platform.

The effect exerted on the deformation characteristic by the enclosed air volume may be changed, in one embodiment of the invention, by the pressure of the gas enclosed in the profile element being adjustable.

An influencing of the deformation characteristic of the profile elements may also be effected by the profile element including at least one variation of its wall thickness. Relatively thin regions of the wall of the profile element can be deformed more easily than neighbouring, thicker regions. One possible application of this principle consists in introducing so-called “thin-place hinges”, about which two neighbouring regions of the profile element can perform a kind of rotary movement.

### BRIEF DESCRIPTION OF THE DRAWINGS

Embodiments of the invention are described in more detail hereinafter with the aid of the drawings, in which:

FIG. 1a shows isometrically a first exemplary embodiment of an elevating platform according to the invention in the retracted position;

FIG. 1b shows the elevating platform of FIG. 1a with the upper structure removed;

FIG. 1c shows the elevating platform of FIGS. 1a and 1b in the extended position;

FIG. 1d shows the elevating platform of FIG. 1c with the upper structure removed;

FIG. 2 shows in an isometric illustration a detail of the elevating platform of FIG. 1a to 1d;

FIGS. 3 to 9 show further embodiments of elevating platforms according to the invention, the subfigures a and b each showing the elevating platform in the retracted position and the subfigures c and d showing the elevating platform in the extended position;

FIG. 10 shows in side view an elevating platform configured as a sliding platform and based on the design principle of the elevating platform illustrated in FIGS. 1 and 2;

FIG. 11 shows a single profile element with a separately attached sliding strip.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

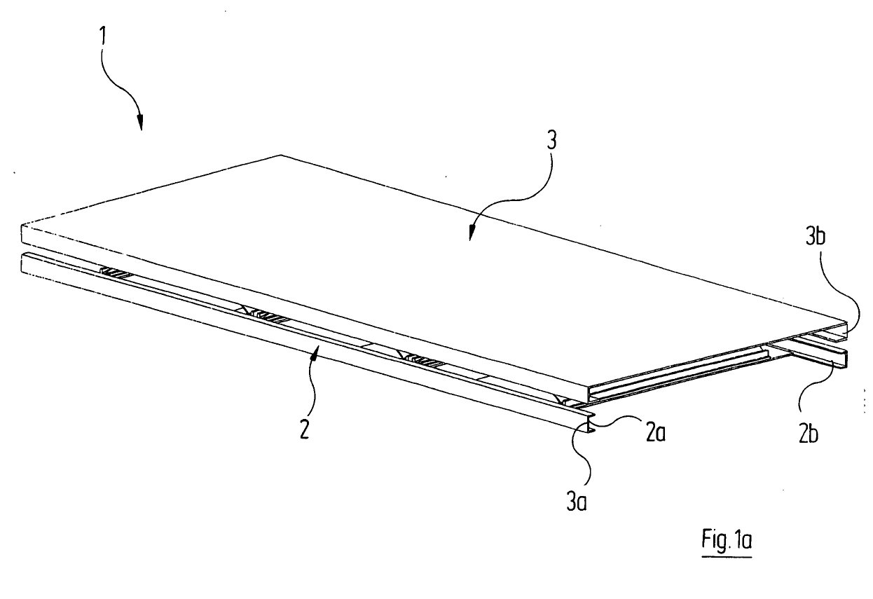

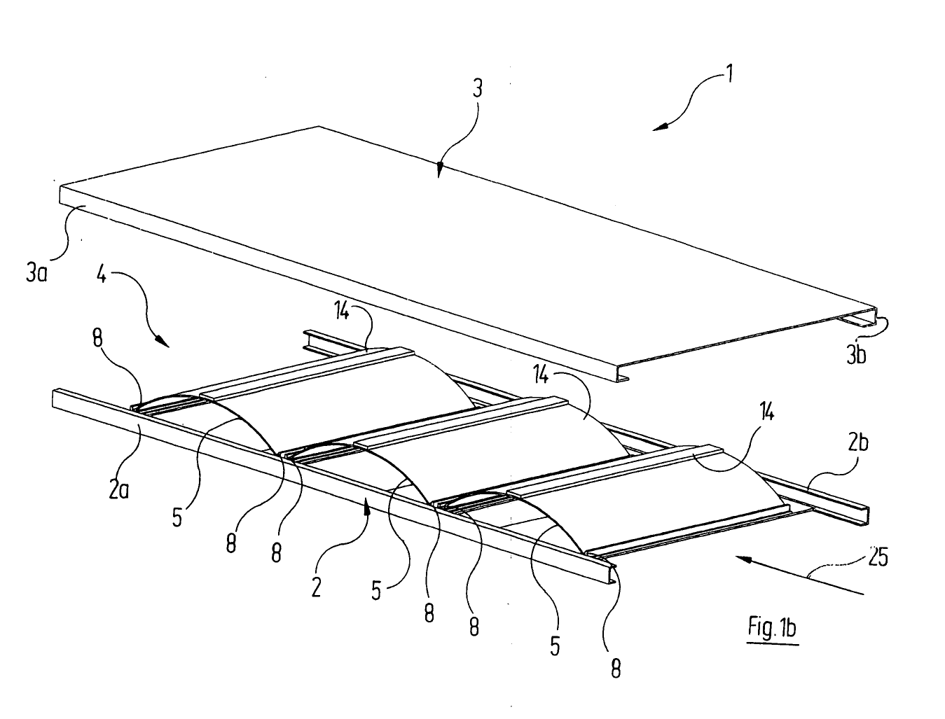

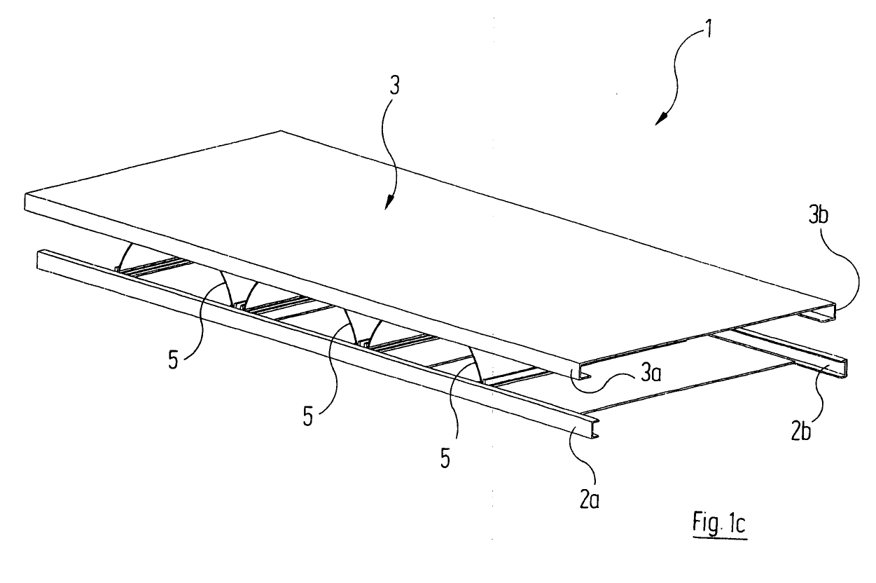

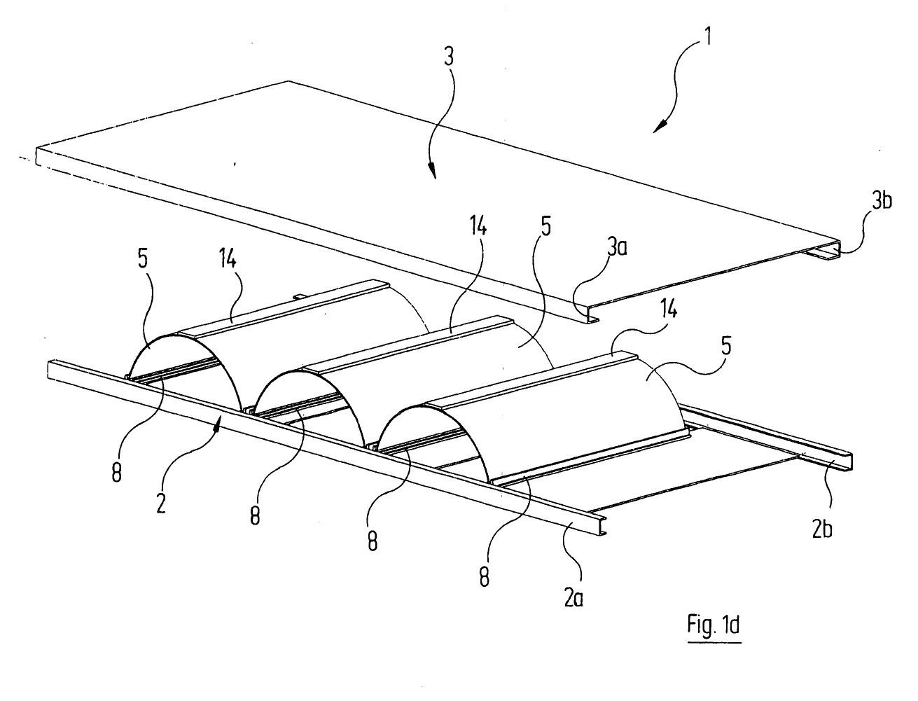

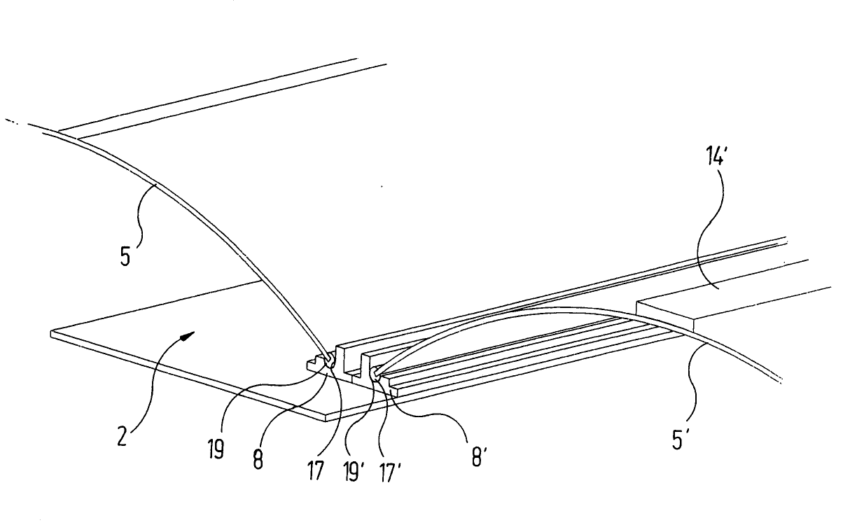

Reference is made first of all to FIGS. 1a to 1d and 2. These figures schematically illustrate an elevating platform, which is denoted as a whole by the reference symbol 1 and is intended primarily for lifting and lowering heavy loads with a short stroke. Like all elevating platforms, this elevating platform 1 also comprises a lower structure 2 which can be fastened to a floor or another supporting structure, an upper structure 3 receiving the load, and a connecting structure 4 arranged between the lower structure 2 and the upper structure 3.

In the exemplary embodiment illustrated, the lower structure 2 possesses two parallel C-beams 2a, 2b, while the upper structure 3 is configured as a plane supporting plate with double-bent longitudinal edges 3a, 3b.

The connecting structure 4 for its part comprises three shell-shaped profile elements 5, which in the relaxed state illustrated in FIG. 1b have the shape of rectangular cutouts from a circular cylinder lateral surface with a relatively large radius. The axes belonging to the cylinder lateral surfaces run here perpendicular to the direction of extension of the two parallel profile beams 2a, 2b.

The axially parallel edges of the profile elements 5 are each fastened, in a manner described below with reference to FIG. 2, in a strip 8 which is slidably guided by its opposite ends in each case in the two profile beams 2a, 2b. If the entire arrangement consisting of the profile elements 5 and the strips 8 is to be prevented from being able to slide along the profile beams 2a and 2b, one or two neighbouring strips 8 can also be fixed to the profile rails 2a, 2b. It is assumed below that the strip 8 located on the extreme left in FIG. 1b is fastened, for example screwed, to the profile beams 2a, 2b.

In the region of the upper vertex line of the profile elements 5, a rib-shaped projection 14 with a plane supporting surface is formed on in each case. If the upper structure 3 is simply placed on the supporting surfaces of the projections 14, the compact appearance of the elevating platform 1 illustrated in FIG. 1a results.

If a force is exerted on the strip 8 located on the extreme right in FIG. 1b in the direction of the arrow 25, this force attempts to push this strip 8 to the left in FIG. 1b, whereby the profile elements 5 are deformed in the sense of a reduction of their radius of curvature. The vertex line of the profile elements 5 with the rib-like projections 14 travels upwards during this elastic deformation, as illustrated in FIG. 1d. The upper structure 3 and the load fastened thereon are raised to a corresponding extent. During this movement, only the strip 8 situated on the far left remains stationary, while all the other strips 8 move in correspondence with the shortening of the dimension of the profile elements 5 in the direction of the profile beams 2a, 2b. This is accompanied by a corresponding movement of the upper structure 3 and the load fastened thereon. The elevating platform 1 now has the appearance illustrated in FIG. 1c.

The profile elements 5 consist of elastic material, for example sheet steel, but preferably of fibre-reinforced plastic. If the force illustrated by the arrow 25 in FIG. 1b is removed, the profile elements 25 therefore relax again and are returned to the position illustrated in FIGS. 1a and 1b under the displacement of the movable strips 8 and the upper structure 3. The elastic forces acting in the profile elements 5 cooperate here with the weight forces resulting from the load and the upper structure 3 itself.

Since the bearing surfaces of the rib-like projections 14 do not all move to the same extent laterally (horizontally) between the retracted position of the elevating platform 1 according to FIGS. 1a and 1b and the extended position according to FIGS. 1c and 1d, suitable materials or other measures are used to ensure that the bearing surfaces of the rib-like projections 14 can slide with low friction along the underside of the upper structure 3. The projection 14 which moves the least can be fixed to the upper structure 3.

The detail view of FIG. 2 shows how two neighbouring profile elements 5, 5′ are fastened by their neighbouring longitudinal edges to two strips 8, 8′. For this purpose, each profile element 5, 5′ possesses at its longitudinal edges fastening ribs 17, 17′ of circular cross-section, which are introduced into grooves 19, 19′ of semicircular cross-section in the two strips 8, 8′. When the profile elements 5, 5′ are deformed during the actuation of the elevating platform 1, the fastening ribs 17, 17′ rotate hinge-like in the associated grooves 19, 19′ of the strips 8, 8′. In this way, excessive local deformations and forces in the region of the edges of the profile elements 5 are avoided.

If is of course possible for the force which is employed to deform the profile elements 5 not to be applied unilaterally at one end of the row of profile elements 5. In many cases, it is even more expedient to introduce the force required to lift the elevating platform 1 at both end strips 8 of the elevating platform 1, neither of which of course must then be fastened to the profile beams 2a, 2b, but must both be able to slide along the profile beams 2a, 2b. The advantage of this kind of force introduction is that the upper structure 3 essentially does not move parallel to the profile beams 2a, 2b (laterally); it can then even be fastened to the rib-like projection 14 of the middle profile element 5. In this case, no relative movement takes place here between the upper structure 3 and the profile element 5.

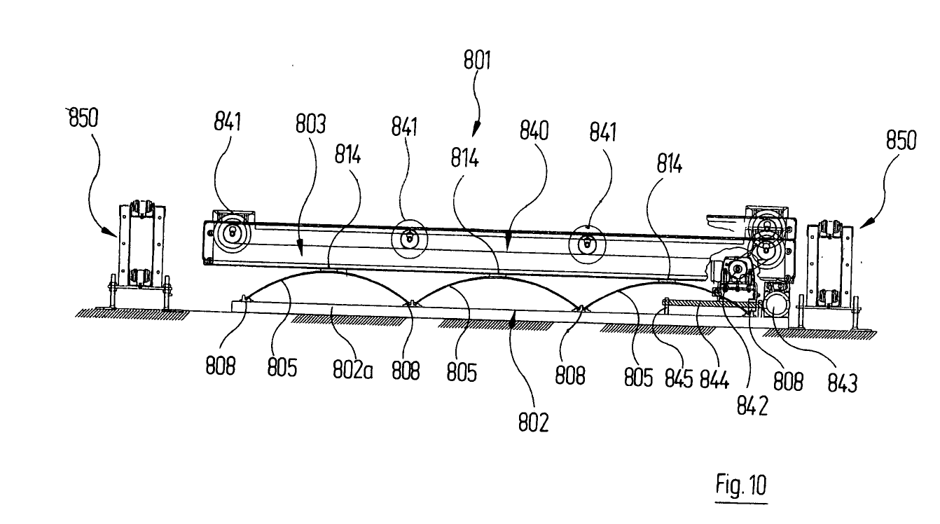

In principle, it is unimportant for the present invention how the force used to deform the profile elements 5 for raising the upper structure 3 is produced. In particular, rope drives or threaded spindles are suitable for this. An example for such a spindle drive is explained below with reference to FIG. 10. If rope drives are employed, they can be guided in the manner of a block and tackle, so that additional force amplification is thus obtained.

In principle, the number of profile elements 5 employed in a particular elevating platform 1 is not restricted. In individual cases, a single lifting element 5 may even be sufficient. In the case of large-area elevating platforms 1, it is also possible to employ a large number of profile elements 5.

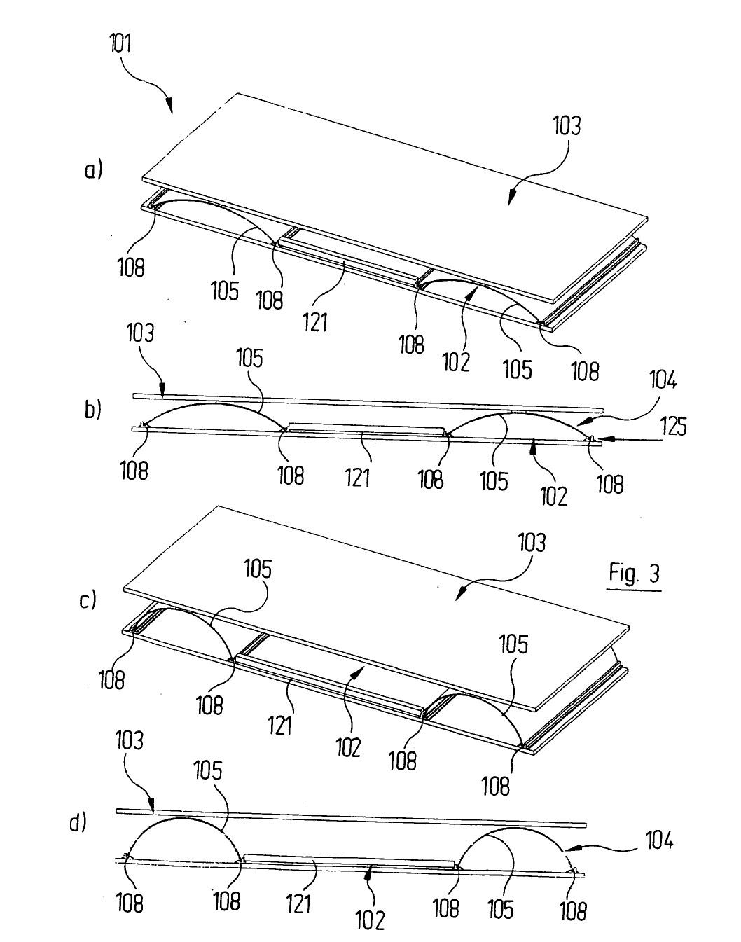

The profile elements do not necessarily need to butt against one another by their longitudinal edges within the connecting structure. FIG. 3 illustrates an exemplary embodiment of an elevating platform which is largely similar to that which has been described above with reference to FIGS. 1a to 1d. Corresponding parts are therefore denoted by the same reference symbol plus 100.

The elevating platform 101 again has a lower structure 102, embodied here as a plate, and an upper structure 103, likewise designed as a plate. The connecting structure 104 here comprises only two shell-shaped, downwardly open profile elements 105, whose longitudinal edges parallel to the axes of the circular cylinder lateral surfaces are each fastened in a strip 108. The fastening is effected in the same way as described above with reference to FIG. 2. The strips 108 are, with one exception which will be discussed below, slidably guided on the bottom structure 102 perpendicularly to their longitudinal extent in a manner not explained in more detail.

Instead of the middle profile element 5 of the exemplary embodiment of FIGS. 1a to 1d, the connecting structure 104 of the exemplary embodiment of FIG. 3 possesses two rigid distance elements in the form of bars 121 which are inserted between the mutually facing inner strips 8 of the two profile elements 105. The strip 108 located farthest to the left is again assumed to be fixed. If force is now applied in the direction of the arrow 125 to the strip located farthest to the right in FIG. 3, the two profile elements 105 are deformed in a similar manner to that in FIG. 1 with reduction of the radius of curvature and raising of their vertex lines and the upper structure 103 resting thereon. The extended position of the elevating platform 101 is illustrated in FIGS. 3c and 3d, which require no further explanation.

It is of course possible also in the case of the elevating platform 101 of FIG. 3 to introduce forces on opposite sides of the connecting structure 104.

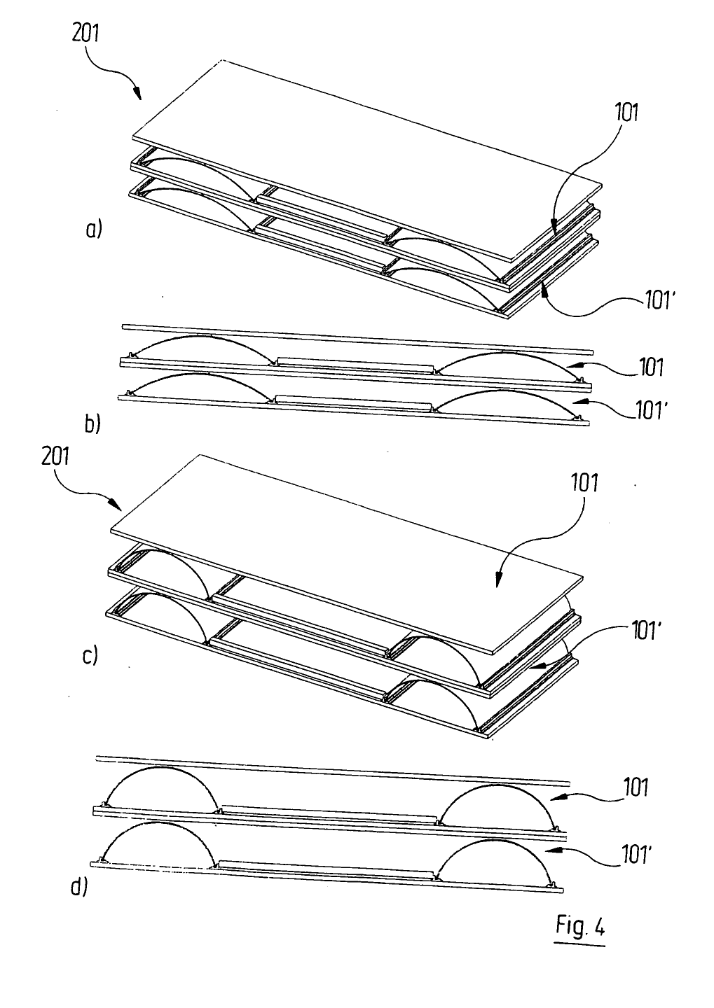

With the elevating platforms 1 and 101 respectively illustrated in FIGS. 1 to 3, understandably only a comparatively short stroke can be achieved. It is possible to increase this stroke simply by placing a plurality of such elevating platforms 1 or 101 on top of one another and thus forming a new elevating platform 201, as illustrated in FIGS. 4a to 4d. The elevating platform 201 in this case consists of two “sub-elevating platforms” 101, 101′ of the kind illustrated in FIG. 3, the lower structure of the upper elevating platform 101 being placed on the upper structure of the lower elevating platform 101′. The two sub-elevating platforms 101, 101′ can be actuated either simultaneously by the same source of force or by independent sources of force. The maximum stroke of the elevating platform 201 obviously corresponds to the sum of the strokes of the individual sub-elevating platforms 101, 101′.

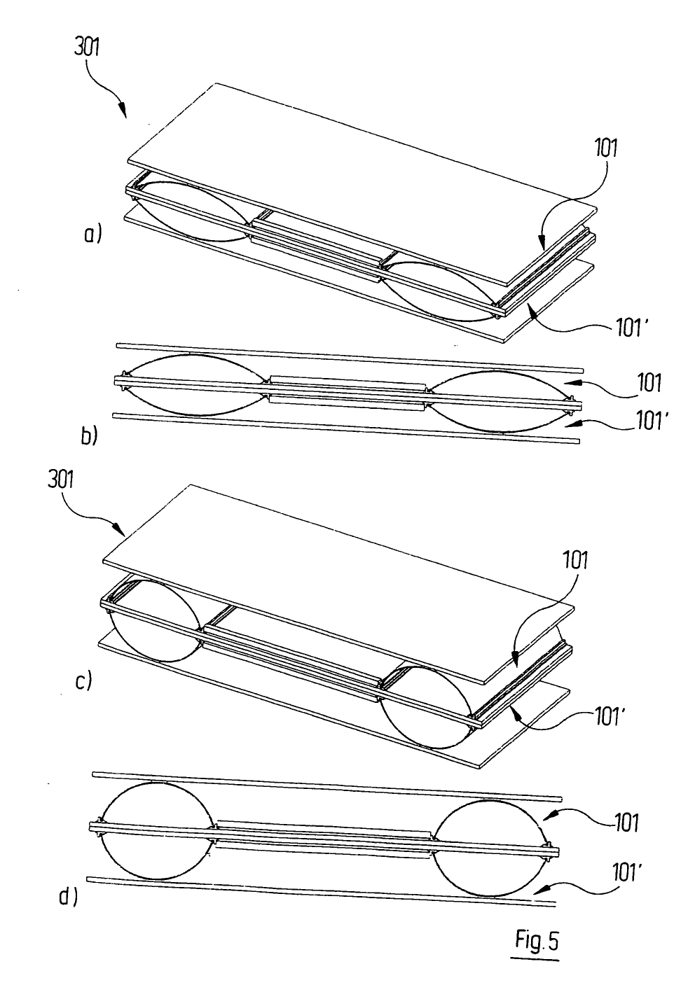

Another way of putting together two sub-elevating platforms 101, 101′ of the kind shown in FIG. 3 to form an elevating platform 301 is illustrated in FIG. 5. Here, the sub-elevating platforms 101, 101′ are stacked “in opposite directions” on top of one another. This means that, in the case illustrated, the upper sub-elevating platform 101 is oriented in space in the manner illustrated in FIG. 3, in which the “lower structure” actually lies at the bottom, while the lower sub-elevating platform 101′ is upside down as it were, so that its lower structure lies at the top and in contact with the lower structure of the upper sub-elevating platform 101. Once again, the total stroke of the elevating platform 301 is equal to the sum of the strokes of the two sub-elevating platforms 101, 101′.

In the embodiment of FIG. 5 too, the sub-elevating platforms 101, 101′ can be actuated either synchronously by a common source of force or independently of one another by separate sources of force.

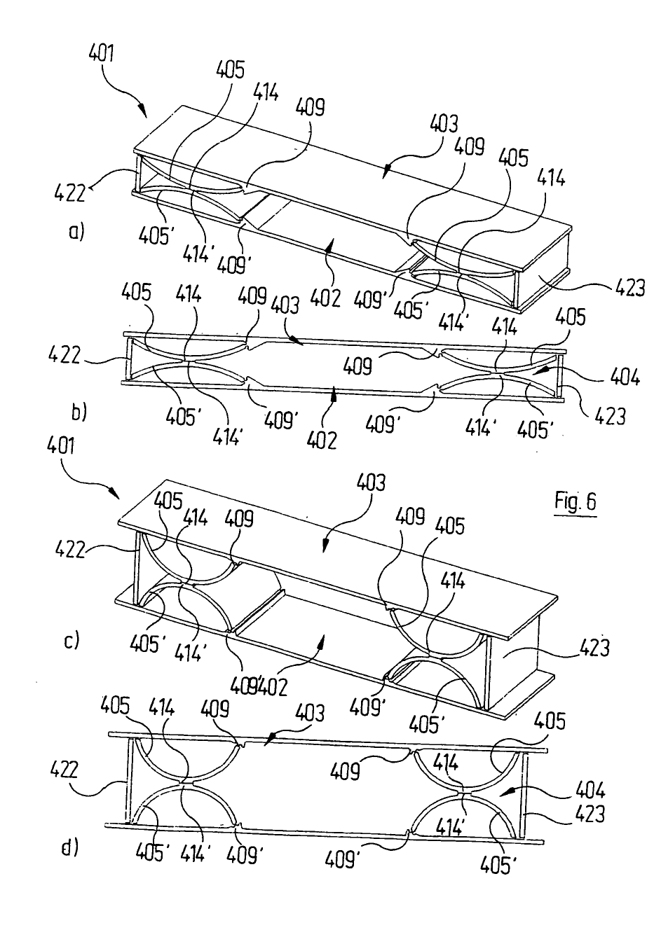

In the case of the elevating platform 401 illustrated in FIG. 6 too, a plurality of elastically deformable profile elements 405, 405′ are arranged above one another in pairs to increase the total stroke. The elevating platform 401 is, however, not a complete multiplication of a “sub-elevating platform”. Rather, here the profile elements 405, 405′, which lie against one another in each case in pairs and are configured as partial cylinder lateral surfaces, are placed in opposite directions directly against one another such that in each case the lower profile element 405′ is downwardly open and the upper profile element 405 is upwardly open. The mutual contact of the profile elements 405, 405′ takes place via the rib-like projections 414, 414′ along the vertex lines.

The respective inner longitudinal edges, running parallel to the axis of the partial cylinder lateral surfaces, of the profile elements 405, 405′ are integrally attached, via a thin place acting as a hinge, to a rib 409, 409′ respectively formed on the lower structure 402 and upper structure 403 and running parallel to these edges. The respective outer longitudinal edges of the profile elements 405, 405′ lie against vertical actuating plates 422, 423 which are guided on the lower structure 402 and the upper structure 403 so as to be movable in a direction towards and away from one another.

Obviously, this design is such that, by subjecting the actuating plates 422, 423 to a force, the outer longitudinal edges of the profile elements 405, 405′ are guided inwards, whereby the profile elements 405, 405′ are deformed and their respective vertex line is moved a greater distance from the neighbouring lower structure 402 and upper structure 403. These processes can be easily understood by comparing FIGS. 6a and 6b with FIGS. 6c, 6d.

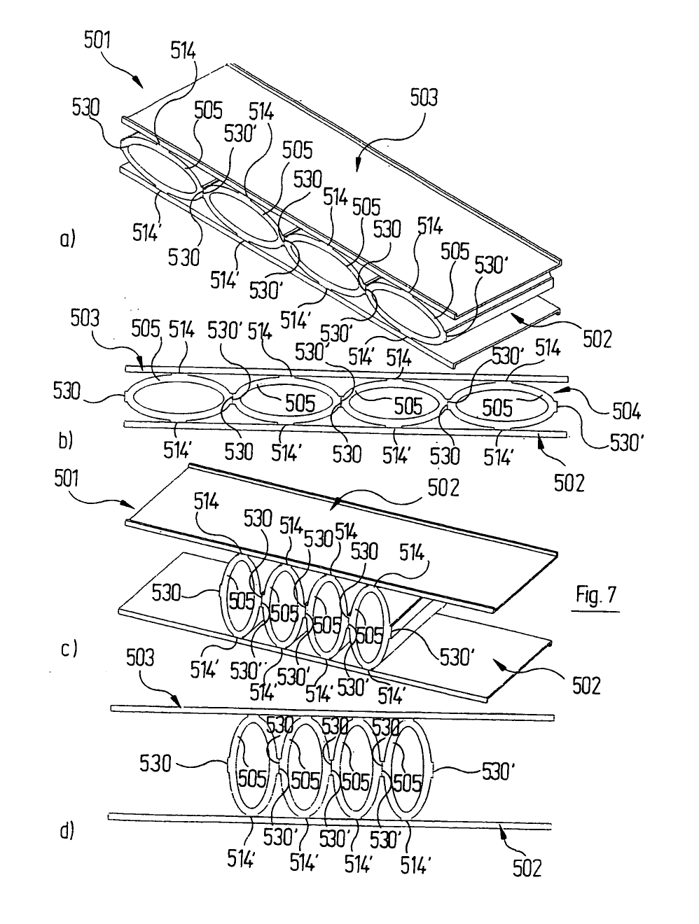

In the exemplary embodiment of an elevating platform 501 illustrated in FIG. 7, the connecting structure 504 arranged between the lower structure 502 and the upper structure 503 comprises a multiplicity of tubular profile elements 505 arranged parallel to one another and in a manner butting against one another. Each of these profile elements 505 can be understood as being composed in one piece of two shell-shaped profile elements, as shown in FIGS. 1 to 3.

In the “retracted” state of the elevating platform 501, as illustrated in FIGS. 5a and 5b, the elastic profile elements 505 possess essentially an elliptical cross-section, the longer major axis being arranged horizontally, i.e. parallel to the lower structure 502 and to the upper structure 503. Again rib-like projections 514, 514′, against which respectively the lower structure 502 and the upper structure 503 lies, run along the vertex lines which are assigned to the short ellipse axes.

Likewise rib-shaped projections 530, 530′, which form bearing surfaces and via which neighbouring profile elements 505 lie against one another, run along the vertex lines of the profile elements 505 which are assigned to the long ellipse axes. The projections 530 and 530′ located on the extreme left and right serve for introducing the forces required to raise the upper structure 502, for example again via actuating plates, similar to those provided in the exemplary embodiment of FIG. 6.

If the tubular profile elements 505 are deformed in this way, the state illustrated in FIGS. 7a and 7b results in the state which can be seen in FIGS. 7c and 7d. In this state, the tubular profile elements 505 once again possess an elliptical cross-section, after they have passed through an intermediate state in which the cross-section was approximately circular. In FIGS. 7c, 7d, in the vicinity of the end of the stroke of the upper structure 502, the longer ellipse axis of the cross-section of the profile elements 505 runs vertically and the shorter ellipse axis runs horizontally. With the elevating platform 501 extended, the profile elements 505 therefore move closer together and become narrower.

The end sides of the tubular profile elements 505 are open, so that the air enclosed in their interior can escape during the deformation. In principle, however, it is also possible to close these end faces, which has an effect on the “rigidity” and the load-carrying capacity of the profile elements 505. Optionally, it is also possible to make the pressure of the gas, for example the air, inside the closed profile elements 505 adjustable. This adjustable pressure is not, however, to be confused with the pressure used, for example, to inflate a bellows-like lifting apparatus. In the case of the present invention, during the actual operation of the elevating platform, the enclosed quantity of gas is not changed by supplying or removing gas; the lifting movement takes place solely on account of the deformation of the profile elements by a force acting in the lateral direction.

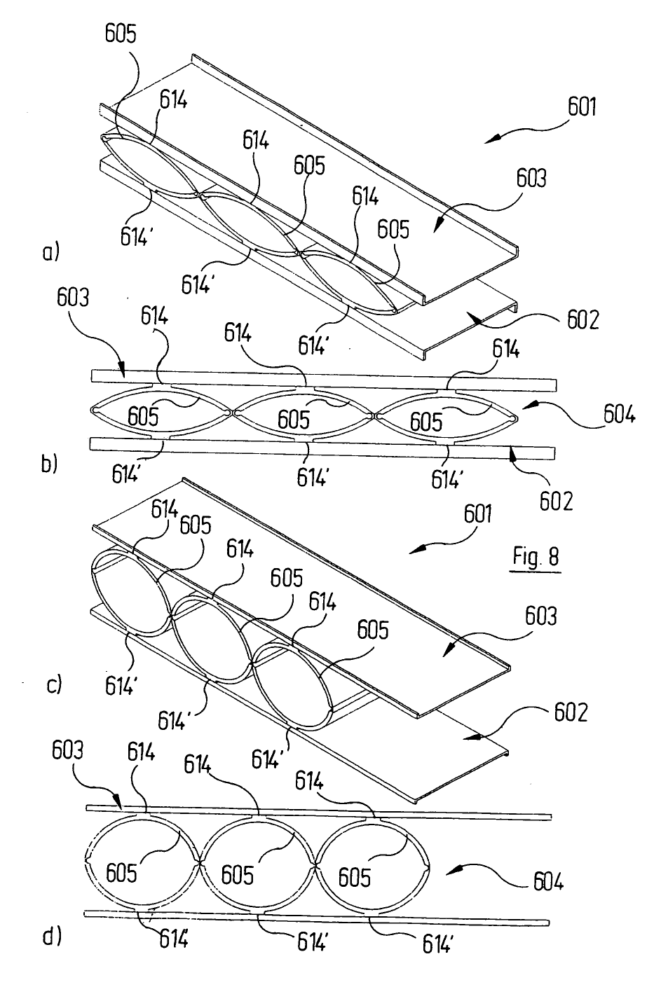

In the case of the elevating platform 601 illustrated in FIG. 8, the circumstances are very similar to those in the case of the elevating platform 501 of FIG. 7. Once again, the connecting structure 604 consists of a plurality of tubular elastic profile elements 605 lying against one another, which elements lie against the lower structure 602 at their underside via a rib-like projection 614′ and lie against the upper structure 603 at the upper side in each case via a rib-like projection 614. The cross-section of the profile elements 605 is, however, not elliptical in the strict sense; rather, it can be imagined as being composed in one piece of two shell-shaped subelements forming partial cylinder lateral surfaces, which correspond to those of FIGS. 1 and 2. These partial elements are now joined together at their longitudinal edges via thin-place hinges which open when the upper structure 603 is being raised, as can be seen from FIGS. 8c and 8d, and close when the upper structure 603 is being lowered, in accordance with FIGS. 8a and 8b.

This embodiment again has the advantage that, on extension and retraction of the elevating platform 601, no high local deformations and thus stresses are formed in the vicinity of the lateral vertex lines of the profile elements 605.

In other respects, what was stated above with regard to the exemplary embodiment of FIG. 7, applies analogously to that of FIG. 8.

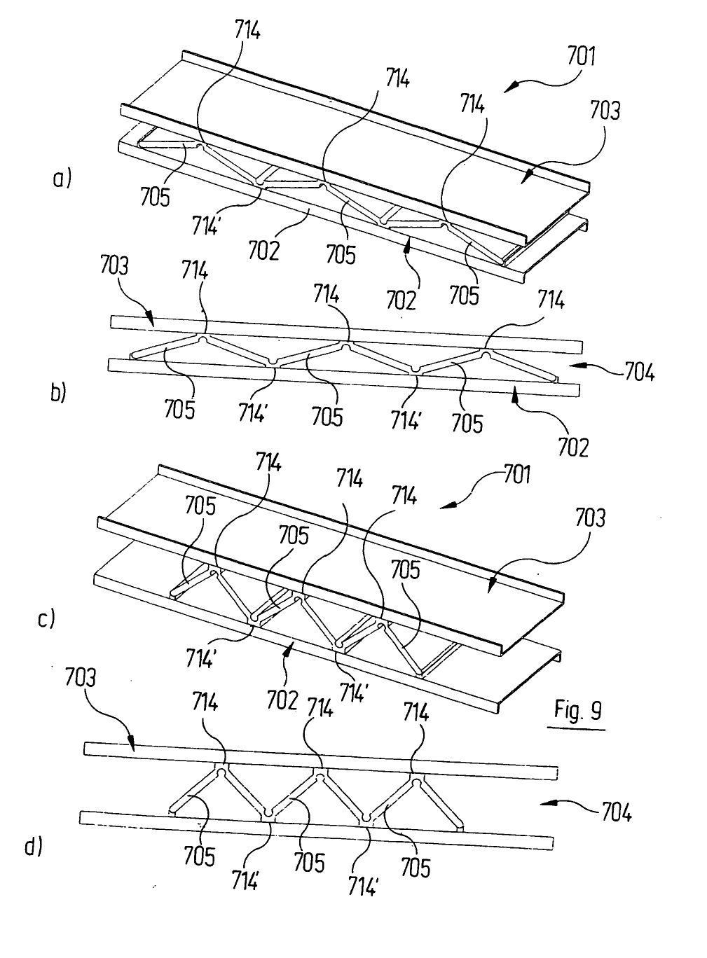

The exemplary embodiment of an elevating platform 701 illustrated in FIG. 9 is very similar to that described above with reference to FIGS. 1 and 2. It differs from the latter essentially only by the kind of profile elements which form the connecting structure 704. The differences are essentially as follows:

While in the exemplary embodiment of FIGS. 1 and 2 a plurality of shell-shaped profile elements 5 designed as separate parts were provided, the connecting structure 704 comprises only a single, one-piece profile part. The latter again is composed of three subprofiles 705 integrally joined together at neighbouring edges. The subprofiles 705 have essentially a roof shape with two approximately plane limbs which enclose an angle at a “roof ridge”. Since the lower connecting points between neighbouring subprofiles 705 possess the same geometry as the aforementioned “roof ridge” of the subprofiles 705, the division into subprofiles is somewhat arbitrary; the connecting structure 704 can also be understood as a profile element running in a zigzag manner between the lower structure 702 and the upper structure 703.

The individual roughly plane limbs of the connecting structure 704 are joined together via thin places formed by grooves and acting in the manner of hinges. On deformation of the connecting structure 704 to raise the upper structure 703, the limbs of the connecting structure 704 remain essentially plane. Essentially only the angle enclosed by neighbouring limbs changes, the angle being greater in the “retracted” state of the elevating platform 701 than in the extended state.

While the above explanations of various embodiments of elevating platforms 1 to 701 provided with reference to FIGS. 1 to 9 were essentially of a schematic nature, FIG. 10 is a realistic illustration of the way in which an elevating platform 801 according to the invention can be employed in practice as a sliding platform. The elevating platform 801 is very similar in its basic design to the exemplary embodiment of FIGS. 1 and 2. This means that the elevating platform 801 has a lower structure 802 consisting of two profile beams 802a and 802b running parallel (in FIG. 10 only the front profile beam 802a can be seen).

The upper structure 803, which is supported on the lower structure 802 via a connecting structure 804, carries in FIG. 10 a roller conveyor 840, which for its part comprises a multiplicity of rollers 841 arranged at a distance from one another. The axes of rotation of the rollers 841 run perpendicularly to the plane of the drawing of FIG. 10. Objects placed on the rollers 841 can therefore be moved to the left or right in FIG. 10 by rotating the rollers 841.

The rollers 841 are driven in a known manner by a geared motor 842 and various belts. The edges, running parallel to the axis of the partial cylinder lateral surface, of the three shell-shaped elastic profile elements 805 are again linked to strips 808, as illustrated in FIG. 2. The strip 808 located farthest to the left in FIG. 10 is fixed, while all other strips 808 are slidably guided along the profile beams 802a parallel to themselves in FIG. 10.

The force leading to a lateral compression of the profile elements 805 and thus to a raising of the upper structure 803 and of the roller conveyor 840 carried by the latter comes from an electric motor 843, which is arranged at the edge of the elevating platform 801 in this exemplary embodiment. The electric motor 843 drives a threaded spindle 844, which extends parallel to and between the profile beams 802a, 802b and is rotatably mounted at its free end in a bearing pedestal 845. A nut 846, which is connected to the strip 808 located farthest to the right in FIG. 10, runs on this threaded spindle 844.

The entire elevating platform 801 is arranged between two roller strips 850 running parallel, perpendicularly to the plane of the drawing of FIG. 10. Each of these roller strips 850 comprises at its upper side a multiplicity of rollers 852 which are arranged at a distance from one another and can be driven in a known manner.

The arrangement consisting of roller strips 850 and elevating platform 801 illustrated in FIG. 10 operates as follows:

An object which bridges the intervening space between the two roller strips 850 and lies on the rollers 852 of the two roller strips 850 is transported perpendicularly to the plane of the drawing of FIG. 10 by corresponding rotation of the rollers 852 until it is in a position directly above the upper structure 803 of the elevating platform 801. Here, the rollers 852 stop, so that the object in question comes to a standstill. At this point in time, the elevating platform 801 is situated in the “retracted” position illustrated in FIG. 10, in which the rollers 841 of the roller conveyor 840 carried by the upper structure 803 are still below the object, at a distance therefrom. The nut 848 on the threaded spindle 844 is situated relatively close to the electric motor 843; the profile elements 805 are largely relaxed and the radius of the partial cylinder lateral surfaces forming them is relatively large.

Now, the electric motor 843 is put into operation. By rotation of the threaded spindle 844, the nut 848 is conveyed to the left in FIG. 10; the strip 808 located farthest to the right in FIG. 10 is carried along by the nut 848, so that the profile elements 805 are deformed in the manner explained above with reference to FIGS. 1 and 2. In the process, the upper structure 803 is raised until the rollers 841 lie against the underside of the object and eventually, during the further vertical movement of the upper structure 803, lift this object off the rollers 852 of the roller strips 850. Now, the electric motor 842 can be supplied with current in the desired direction, so that the rollers 841 transport the object to the right or left in FIG. 10 to a further conveying system or into a processing station.

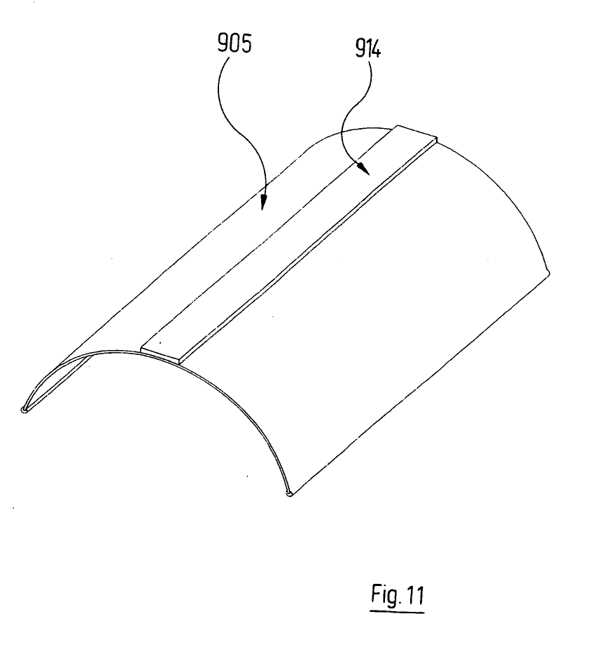

In the above-described exemplary embodiments of elevating platforms, the various profile elements were integrally joined to the rib-like projections, which provide plane bearing or supporting surfaces. This is different in the case of the profile element 905 illustrated in FIG. 11. The rib-like projection 914 used here is a separately fabricated part which consists of low-friction plastic and has been subsequently connected to the rest of the profile element 905. The choice of material for the profile element 905 can then be made solely with regard to elasticity, flexural strength and mechanical stability.

It should be emphasized that the above-described embodiments of the present invention, particularly, any “preferred” embodiments, are possible examples of implementations merely set forth for a clear understanding of the principles of the invention. Many variations and modifications may be made to the above-described embodiments of the invention without substantially departing from the spirit and principles of the invention. All such modifications are intended to be included herein within the scope of this disclosure and the present invention, and protected by the following claims.

1. An elevating platform for lifting and lowering heavy loads, the elevating platform, comprising:
a) a lower structure which can be arranged on a room floor or another supporting structure;
b) an upper structure, on which the load can be arranged;
c) a connecting structure which extends between the lower structure and upper structure and the vertical dimension of which can be changed such that the upper structure can be raised or lowered with respect to the lower structure;
d) a source of force acting on the connecting structure, which brings about the change of the vertical dimension of the connecting structure,
wherein
e) the connecting structure comprising one elastically deformable profile element, the vertical dimension of which can be changed by the fact that it can be subjected to a force in the horizontal direction.

2. The elevating platform according to claim 1, wherein the source of force comprises a motor and a horizontally running threaded spindle driven by the latter, as well as a threaded nut which can be screwed on the threaded spindle and is in force-fitting connection with a lateral region of a profile element.

3. The elevating platform according to claim 1, wherein the source of force comprises a motor and a drum which is driven by the latter and onto which can be wound a flexible drive means, in particular a rope, which is connected to a lateral region of a profile element and runs horizontally at least in the region neighbouring the profile element.

4. The elevating platform according to claim 1, wherein the force can be introduced unilaterally at a lateral region of a profile element.

5. The elevating platform according to claim 1, wherein the force can be introduced bilaterally at two opposite lateral regions of the same profile element or different profile elements.

6. The elevating platform according to claim 1, wherein at least two profile elements are arranged beside one another.

7. The elevating platform according to claim 6, wherein neighbouring profile elements butt directly against one another by way of lateral regions.

8. The elevating platform according to claim 6, wherein neighbouring profile elements are laterally spaced from one another.

9. The elevating platform according to claim 8, wherein at least one force-transmitting distance piece is arranged between neighbouring profile elements.

10. The elevating platform according to claim 8, wherein at least one lateral region of at least one profile element is stationarily connected to the lower structure and/or the upper structure.

11. The elevating platform according to claim 1, wherein at least two profile elements are arranged above one another.

12. The elevating platform according to claim 11, wherein at least two profile elements are arranged in the same direction above one another.

13. The elevating platform according to claim 11, wherein at least two profile elements are arranged in opposite directions above one another.

14. The elevating platform according to claim 12, wherein it is composed of two sub-elevating platforms, each of which possesses a lower structure, a connecting structure and an upper structure.

15. The elevating platform according to claim 11, wherein at least two profile elements are arranged above one another in a manner lying directly against one another.

16. The elevating platform according to claim 1, wherein at least one profile element is provided, at an upper or lower vertex region by which it lies against the lower structure or against the upper structure or against the vertex region of another profile element with a rib-like projection which forms a plane supporting surface.

17. The elevating platform according to claim 16, wherein the rib-like projection is a separate part connected to the profile element and made of low-friction plastic.

18. The elevating platform according to claim 7, wherein at least two profile elements are provided, at their lateral regions butting against one another, with a rib-like projection which forms a plane bearing surface.

19. The elevating platform according to claim 1, wherein the at least one profile element is open on one side.

20. The elevating platform according to claim 19, wherein the profile element has the shape of a circular cylinder partial lateral surface.

21. The elevating platform according to claim 19, wherein the profile element is shaped in the manner of a roof.

22. The elevating platform according to claim 19, wherein at least one edge of a profile element is fastened in a component which is slidably guided along the lower structure or the upper structure.

23. The elevating platform according to claim 1, wherein at least two profile elements (705) are integrally joined together.

24. The elevating platform according to claim 1, wherein at least one profile element is of tubular configuration.

25. The elevating platform according to claim 24, wherein the tubular profile element is open at opposite ends.

26. The elevating platform according to claim 24, wherein the tubular profile element is closed all the way round.

27. The elevating platform according to claim 26, wherein the pressure of the gas enclosed in the profile element is adjustable.

28. The elevating platform according to claim 1, wherein at least one profile element has at least one variation of its wall thickness in order to influence its deformation behaviour.
